(19) United States
(12) Patent Application Publication
(10) Pub. No.: US 2018/0038322 A1
(43) Pub. Date: Feb. 8, 2018

(54) INTERNAL COMBUSTION ENGINE WITH REDUCED EXHAUST TOXICITY AND WASTE

(71) Applicant: Jeffrey J. Karl, Williamsburg, MA (US)

(72) Inventor: Jeffrey J. Karl, Williamsburg, MA (US)

(21) Appl. No.: 15/653,251

(22) Filed: Jul. 18, 2017

Related U.S. Application Data
(60) Provisional application No. 62/371,995, filed on Aug. 8, 2016.

(51) Int. Cl. F02M 27/04; F02D 41/26; F02F 11/00; F02D 41/14; F02F 1/24

(52) U.S. Cl. CPC F02M 27/04; F02D 41/1441; F02F 1/24; F02F 11/002; F02D 41/26

(57) ABSTRACT

An internal combustion engine generates a cleaner exhaust. A combustion chamber combusts a fuel and generates combustion products. A fuel inlet channel introduces the fuel into the combustion chamber. An air inlet channel introduces air into the combustion chamber. An outlet channel discharges the combustion products from the combustion chamber. A set of electrodes is arranged inside the internal combustion engine that generate an electric field in contact with the fuel, the air and/or the combustion products when a voltage is applied across the set of electrodes. A sensor is arranged inside the internal combustion engine that measures a combustion condition. A controller adapts the electric field based on the combustion condition. The engine generates exhaust with reduced toxicity and waste product relative to prior combustion engines by energizing a fluid mixture of fuel, air, and combustion products to improve a redox reaction causing a more complete combustion reaction.

### CROSS-REFERENCE TO RELATED APPLICATION(S)

This application claims priority to, and the benefit of, co-pending U.S. Provisional Application No. 62/371,995, filed Aug. 8, 2016, for all subject matter common to both applications. The disclosure of said provisional application is hereby incorporated by reference in its entirety.

### FIELD OF THE INVENTION

The invention relates to an internal combustion engine suitable for use in a motor-vehicle. The internal combustion engine generates exhaust with reduced toxicity and waste product relative to prior combustion engine designs by energizing a fluid mixture of fuel, air, and combustion products to improve a redox reaction to cause a more complete combustion reaction, thereby producing less incomplete reaction products in the exhaust gas.

### BACKGROUND

Internal combustion engines are known to convert chemical energy to mechanical energy. An internal combustion engine comprises a combustion chamber wherein fuel is inserted and mixed with air under compression to reactively explode and to form an exhaust gas. The explosive reaction and expansion of the gas push a piston aside to generate mechanical energy.

In U.S. Pat. No. 6,883,490 B2, an internal combustion engine is described. The internal combustion engine as described in this document contains an injector which comprises three electrodes. Tips of the electrodes are arranged to define a polygonal area disposed in proximity to a location where fuel is injected in the combustion chamber. The tips of the electrodes are sourced with electrical power to form an area of electrical ionization in front of or adjacent to the location where fuel is injected. The area of electrical ionization aids the combustion of the fuel, thereby improving fuel efficiency.

In this respect it is observed that governments regulate the exhaust gas from internal combustion engines. For example, the EU has the EURO I-VI regulations and the US EPA has regulations for reciprocating internal combustion engines such as the 40 Code of Federal Regulations Part 63, Subpart ZZZZ. New government regulations demand internal combustion engines to expel less pollution. Hence a cleaner exhaust gas is required. These new regulations drive the need for a cleaner exhaust gas.

### SUMMARY

The present invention expels a cleaner exhaust gas from an internal combustion engine relative to prior known combustion engines. A cleaner gas in the context of the application is a gas that is less toxic and/or containing less unburned hydrocarbons, NOx and/or carbon monoxide.

In a first aspect, the present invention relates to an internal combustion engine comprising: —a combustion chamber for combusting a fuel and thereby generating combustion products; —a fuel inlet channel for introducing the fuel into the combustion chamber; —an air inlet channel for introducing air into the combustion chamber; —an outlet channel for discharging the combustion products from the combustion chamber; —a set of electrodes arranged inside the internal combustion engine for generating an electric field in contact with the fuel, the air and/or the combustion products when a voltage is applied across the set of electrodes; —a sensor arranged inside the internal combustion engine for measuring a combustion condition; and—a controller for adapting the electric field based on the combustion condition.

Combustion of a fuel, such as a hydrocarbon fuel is caused by a reaction, in case of a hydrocarbon fuel between hydrocarbon and oxygen or oxygen containing gas, such as air. The reaction is defined as a redox reaction. The term redox is short for a reduction-oxidation reaction. A redox reaction is defined as an exchange of electrons between atoms and/or molecules during atomic or molecular bonding. A fully completed or balanced redox reaction or combustion of a hydrocarbon fuel produces heat, carbon dioxide and water. An incomplete reaction leads, next to complete reaction products, to incomplete combustion products, such as unburned hydrocarbons, NOx and carbon monoxide having a substantial adverse influence on the cleanness of the exhaust gas.

The electric field generated by a voltage across the set of electrodes energizes a fluid inside the electric field. The fluid comprises one or more of the fuel, the air and the combustion products.

Energizing a fluid in the context of the application may mean increasing the temperature of the fluid or the mechanical energy of the molecules in the fluid. A fluid at a predefined higher temperature has an increased reactivity. Energizing a fluid in the context of the application is from a source of electricity. The supply of electricity may have the effect of supplying electrons. The gain of electrons in a redox reaction may have the effect of increasing or supporting predominantly reduction reactivity. Energizing a fluid may have an effect on the electrons in the atoms of the fluid. This effect on the electrons may increase the potential energy and heat released during the atomic exchange in a combustion reaction and likewise effectively control the subsequent reformation of the reaction into combustion products.

Energizing a fluid in the context of the application may mean to break larger molecules into smaller molecules and/or atoms, including radicals, for increasing the chemical reactivity. The supply of electricity for breaking molecular bonds may have the effect of stripping electrons from their bonds. The stripping of electrons in a redox reaction may have the effect of increasing or supporting predominantly oxidation reactivity.

Radicals are defined as unpaired valence electrons. The unpaired valence electrons may have the effect on fuel of splitting long carbon chains to shorter carbon chains. Shorter carbon chains have a higher reactivity compared to longer carbon chains. Energizing a fluid in the context of the application may mean a combination of the above.

This energized fluid has an increased reactivity. The increased reactivity of the energized fluid causes the redox reaction to be improved causing more of the fuel and the air to react to complete reaction products and thereby producing less incomplete reaction products in the exhaust gas.

During the operation, the engine characteristics will change such as engine block temperature, fuel temperature, fuel composition, air pressure, oxygen level in the air and/or combustion chamber temperature. Also over the lifetime of the engine certain characteristics will change, such as the friction of the piston in the combustion chamber, oil leakage into the combustion chamber, leakage causing loss of air pressure during compression and/or wear and tear on the valves leading to and/or from the combustion chamber. All these factors and/or conditions may influence the completeness of the combustion and thereby the cleanness of the exhaust gas.

The sensor measures a combustion condition. The cleanness of the exhaust gas may be derived directly or indirectly from the measurement. The combustion condition may be the measurement of the amount of unburned hydrocarbons, NOx and carbon monoxide in the exhaust gas. The combustion condition may be an indirect measurement, such as the measurement of the amount of fuel or air consumed by the engine over time. Another indirect measurement may be the measurement of engine block temperature, fuel temperature, fuel composition, air pressure, oxygen level in the air or combustion chamber temperature. A sensor may also measure a combination of any of the above mentioned measurements.

The sensor may be arranged to the fuel inlet to the combustion chamber, the air inlet to the combustion chamber, the outlet channel from the combustion chamber, and/or the combustion chamber. The position of the sensor will determine the characteristics that may be measured for adapting the electric field. The changing characteristics of the engine may require a different electric field over a shorter and/or longer time. An example of a shorter time is the warm-up time of an engine after startup. An example of an even shorter time is the change of the electric field during an engine cycle. An example of a longer time is the change of the electric field between engine maintenance.

The controller will receive the measurements from the sensor and adapts the electric field to provide the effect of optimizing redox reactivity. The controller will thus close the feedback loop. The optimized redox reactivity will improve the redox reaction, thereby producing an exhaust gas comprising less incomplete reaction products. An exhaust gas comprising less incomplete reaction products will be cleaner, thereby reaching the object of the invention.

An electric field interacting with a hydrocarbon fuel passing through the electric field prior to combustion may break down longer or larger hydrocarbon molecules in the hydrocarbon fuel. When a strong electric field breaks down the hydrocarbon molecules too much the fuel loses chemical energy. The less energetic fuel will cause a less powerful combustion, hence the internal combustion engine will lose power. A less powerful combustion will result in an increase of incomplete combustion products. Thus, the strong electric field needs to be weakened to provide a cleaner exhaust gas.

When a weak electric field breaks down the hydrocarbon molecules, not enough hydrocarbon molecules in the fuel are broken down. The low amount of broken down hydrocarbon molecules will be harder to combust. Also the low amount of broken down hydrocarbon molecules will result in a lower electric current supplied by the electric field. The higher the electric current, the more redox reactivity is increased. Increased redox reactivity results in an improved combustion. An improved combustion results in a cleaner exhaust gas. Thus, the weaker electric field needs to be made stronger to provide a cleaner exhaust gas.

Hence, the controller controls the electric field to balance the effect of breaking down hydrocarbon molecules in fuel and the effect of breaking down hydrocarbon molecules in fuel too much for providing an engine expelling a cleaner exhaust gas.

An electric field interacting with air passing through the electric field prior to combustion may break down oxygen molecules or oxygen containing molecules in mono-atomic oxygen. Most often the mono-atomic oxygen will quickly (naturally) recombine with O2 to form O3 (ozone). Ozone is highly reactive compared to oxygen, thereby increasing reactivity of the mixture of gases in the combustion chamber. Increased reactivity results in less incomplete combustion products, thus a cleaner exhaust gas is expelled. Thus, the electric field needs to be made stronger to provide an engine expelling a cleaner exhaust gas.

A strong electric field interacting with air passing through the electric field prior to combustion may generate too much ozone. Not all the ozone may be used during combustion. Ozone is a toxic gas providing for a more polluting exhaust gas. Furthermore, this effect is increased by the common practice of providing an air rich mixture to the combustion chamber for combustion. An air rich mixture is defined as a mixture of air and fuel containing such an amount of air that when the fuel completely reacts to complete combustion products, air is left over. Thus, the strong electric field needs to be weakened to provide an engine expelling a cleaner exhaust gas. Furthermore, the strong electric field may generate so much mono-atomic oxygen that not all mono-atomic oxygen is used during combustion, thereby causing excessive energy to be used for generating the strong electric field. Thus, the strong electric field needs to be weakened to prevent excessive energy used for generating a too strong electric field.

Hence, the controller controls the electric field to balance the effect of increasing reactivity by generating mono-atomic oxygen and ozone and the effect of decreasing the amount of ozone expelled for providing an engine expelling a cleaner exhaust gas.

An electric field interacting with both fuel and air during a reaction between reactants in the combustion chamber may increase redox reactivity by stripping and supplying electrons during and after combustion as a unified system. The electric field applied to fuel and oxygen may have the effect of providing a circuit pathway between electrons of both combustion reactants that increases the rate of electron exchange during the atomic exchange and reformation into H₂O and CO₂ products.

An electric field interacting with incomplete combustion products passing through the electric field after combustion may break down molecules of the incomplete combustion products. A hydrocarbon fuel, as part of the incomplete combustion products, may be broken down when the hydrocarbon fuel is passing through the electric field. The broken down hydrocarbon fuel becomes more reactive and may react to complete reaction products, thereby providing a cleaner exhaust gas. Thus, the electric field needs to be made stronger to provide for an engine expelling a cleaner exhaust gas.

A strong electric field interacting with incomplete combustion products passing through the electric field after combustion may break down complete reaction products. A broken down complete reaction product may generate pollution causing a less clean exhaust gas. A carbon dioxide is an example of a complete reaction product, which when broken down may generate carbon monoxide. Carbon monoxide is a component making the exhaust gas less clean. Furthermore, when an air rich mixture is provided to the combustion chamber, air may be converted to ozone polluting the exhaust gas. Furthermore, the strong electric field may saturate, thereby causing excessive energy to be used for generating the strong electric field. Thus, the strong electric field needs to be weakened to prevent excessive energy used for generating a too strong electric field. Thus, the strong electric field needs to be weakened to provide for an engine expelling a cleaner exhaust gas.

Hence, the controller controls the electric field to balance the effect of breaking down incomplete combustion products and the effect of preventing the breakdown of complete reaction products both for providing an engine expelling a cleaner exhaust gas.

In a preferred embodiment of the present invention, the electric field generated by a voltage across the set of electrodes is varied during combustion in or discharge of the combustion chamber. When the electrodes first come in contact during an engine cycle with the fluid, such as fuel, the air and/or the combustion products, the electric field may first cause a discharge across the set of electrodes. The discharge causes the creation of radicals in the fluid. The radicals improve the conductivity of the fluid. The discharge may be followed by an electric field having a lower strength causing an electrical current, preferable a predetermined electrical current, conducted through the fluid with improved conductivity. The step of discharging optionally followed by the step of conducting a current may be repeated multiple times during an engine cycle for further optimizing the redox reactivity, thereby further decreasing the amount of incomplete reaction products in the exhaust gas. In a preferred embodiment the voltage ranges from 6 v to 160 V.

Suitably, the current during the step of conducting has the shape of a DC current, square wave current, sinus current, triangle current, saw tooth current or pulse current. Furthermore, the current may have a frequency between 500 Hz and 10 MHz, preferably between 750 Hz and 100 kHz, more preferably between 1 kHz and 10 kHz for other shapes than DC current. For a specific embodiment an optimum was found at 1.2 kHz. Furthermore, the current flow may have a strength between 100 uA and 10 A, preferably between 1 mA and 5 A, more preferably between 10 mA and 1 A. These amounts and values may be grouped for application in frequency bands hardwired by capacitive circuitry then software driven to be applied in time. The amount and values of the parts used in the circuitry determine a “current profile” is applied according to sensors in real time, driven by a computer program.

In a further embodiment of the present invention the steps of discharging and/or conducting are synchronized with the engine. For example, the synchronized steps may be switched off during loading of, combusting in and/or unloading of the combustion chamber. The synchronized steps may be related to the condition of redox reactivity, where the current profile applied to the engine is dynamic, and “tunable” over time and temperature, combustion content, and other determinants mentioned elsewhere.

The electric field generated by the set of electrodes may further be influenced by the environment wherein the electrodes are placed. For example, the electrodes can be positioned proximate to the exhaust outlet to the inside of the combustion cylinder or just outside of the combustion chamber. Locating the electrodes proximate to the exhaust outlet enables the electrodes to be closest to the exhaust temperature without experiencing a temperature drop. The environment comprises the local pressure of a fluid between the electrodes, the temperature of the fluid between the electrodes, and characteristics of the fluid. Such characteristics are electrical conductivity as it relates to chemical bonding, temperature, fluid volume, molecular or atomic state of reformation.

The electric field will have a field strength between 100 kV/cm and 0.1 kV/cm, preferably between 50 kV/cm and 0.3 kV/cm, more preferably 30 kV/cm and 0.5 kV/cm, at a frequency between 500 Hz and 10 MHz, preferably between 750 Hz and 100 kHz, more preferably between 1 kHz and 10 kHz. For a specific embodiment an optimum was found at 1.2 kHz. The electric field will be further influenced by the environment wherein the set of electrodes is positioned. Although two electrodes spaced some distance apart are enough to generate an electric field in accordance with the invention, preferably more electrodes, such as three electrodes may be used. A prototype of a set of six electrodes forming a hexagon has shown promising results.

Electrodes may be made of any material, such materials known to produce an increase in oxidation and or reduction, such as palladium and rhodium for reduction, and platinum for oxidation. Such materials can be mixed and shaped to comprise a screen of multiple strands of wire with rounded or squared edges of contact. With no need to identify anode from cathode, all materials and surfaces are identified as “electrodes”, though plated differently.

The electric field may suitably stretch out over a part of a cross section of the outlet channel, the fuel inlet channel or the air inlet channel. Preferably, the electric field stretches out over the complete cross section. The electric field may suitably stretch out over more than 1 mm, preferably more than 2 mm, more preferably more than 5 mm, even more preferably more than 10 mm and most preferably more than 15 mm of the length of the channel. The length may influence the effectiveness of the electric field's interaction with combustion reactants and products.

An outlet opening may separate the outlet channel from the combustion chamber. An outlet valve may be arranged in the outlet opening. An engine cycle is defined as loading of, combusting in and/or unloading of the combustion chamber.

In a preferred embodiment of the present invention, the set of electrodes is positioned in the air inlet channel. A voltage across the set of electrodes may cause a discharge creating highly reactive oxygen species in the air. Highly reactive oxygen species increase reactivity. The increased reactivity causes less incomplete combustion products and/or more controllable molecular formation from the combustion reactants and products.

In a preferred embodiment of the present invention, the air describes a gas path in the combustion chamber. The set of electrodes in the combustion chamber may be arranged to the gas path for the set of electrodes when generating an electric field, to position the electric field in the gas path. The electric field may generate mono-atomic oxygen from molecular oxygen in the air. Most often the mono-atomic oxygen will quickly (naturally) recombine with O2 to form O3 (ozone). Ozone is highly reactive compared to oxygen, thereby increasing the reactivity of the mixture of gases in the combustion chamber.

In a preferred embodiment of the present invention, the internal combustion engine comprises an injector, and the set of electrodes is arranged to the injector for generating an injector electric field. Fuel injected in the combustion chamber describes a fuel injection path. The injector electric field may be positioned in the fuel inlet channel. The injector electric field may be positioned in the fuel injection path. The injector electric field may discharge creating free radicals from hydrocarbon in the fuel. The free radicals may split long carbon chains to shorter carbon chains. Shorter carbon chains may have increased reduction reactivity ready to be oxidized.

In a preferred embodiment of the present invention, the set of electrodes is positioned in an outlet channel. The redox reaction may still be continuing while gases from the combustion chamber are expelled to the outlet channel. The electric field generated by the set of electrodes positioned in the outlet channel enhances, supports, or lets the redox reactivity continue. The enhancing, continuation, or support of the redox reactivity causes less incomplete combustion products and more controllable molecular reformation from combustion to exhaust after treatment.

In a preferred embodiment of the present invention, a further set of electrodes is arranged downstream from the set of electrodes in the outlet channel. Positioning the further electric field downstream of the set of electrodes provides an interaction with combustion products to varying degree of electric quality through a reduction in temperature and state of molecular reformation. The set of electrodes and the further set of electrodes provide cascading electric fields. The cascading of electric fields provide the advantage of further controlling the redox reactivity as a continuation of the combustion process, with the opportunity to selectively control combustion product reactivity. The selectivity of redox reactivity in combustion products may be accomplished by proper positioning of the electric fields at locations that utilize gaskets. These gaskets containing embedded wires and electrodes are hardwired by circuitry that is software driven to perform as one system.

The exhaust gas drops in temperature and pressure from combustion temperature and pressure to substantially atmospheric temperature and substantially atmospheric pressure respectively. The effect of cascading electric fields in the outlet channel is to control redox reactivity in stages allowing complex systems, such as an internal combustion engine combusting hydrocarbon fuel, to expel cleaner exhaust gas. Preferably, the cascaded electric fields should cooperate to provide a cleaner exhaust gas.

Any gasket containing wires and electrodes related to “combustion” and any related to “exhaust” work as a unified system. The gaskets could be identified as “redox gaskets” or can be identified as oxidization or reduction gaskets.

In a preferred embodiment of the present invention, sets of electrodes are arranged in between the cylinder head and exhaust manifold of a multi-cylinder engine where the sets of electrodes function separately or together to favor oxidation or reduction reactivity to gases that are “mixed” by the manifold shape to be discharged at the outlet of the exhaust manifold. The “mixture” of differently treated exhaust gases in the separate combustion outlets are adjusted according to the shape of the manifold, which is a variable to be identified then further to be “profiled” by a computer program.

During combustion, flame may be the visible gaseous part of combustion. It is caused by a highly exothermic reaction taking place in a thin zone. Very hot flames are hot enough to include ionized gaseous components. The flame and ionized gaseous components may be electrically conductive. The flame may be described as a front propagating through the combustion chamber after combustion initiation. The surface of the flame facing the reactants may be described as a flame front. The surface of the flame facing the products of the combustion may be described as a flame back.

A volume of flame may have charged particles such as positive ions, negative ions, and electrons. A volume of flame and/or charged particles may be electrically conductive. Further, during combustion the redox reaction may cause a flame. During discharge of the combustion chamber the flame and/or electrical conductivity may still be present within the mixture of gases expelled to the outlet channel.

In a preferred embodiment of the present invention, the combustion generates a flame and the electric field is in contact with the flame. For a flame to continue to exist, the flame should be fed with a mixture of fuel and air under the right conditions, such as environment conditions, such as high enough temperature and pressure.

Furthermore, the flame may be fed with charged particles, such as electrons, to prolong the existence of the flame. This feeding of charged particles and/or electrons may be done by energizing the fluid between the set of electrodes. The electric field according to the invention causes the time the flame exists to be prolonged and/or the flame to be intensified. Prolonging and/or intensifying the flame will have the effect that more reaction products react. If more reaction products react, less incomplete combustion products will be expelled from the internal combustion engine.

In a preferred embodiment of the internal combustion engine according to the present invention, the outlet channel, the air inlet channel and/or the fuel inlet channel are arranged inside the cylinder head and the set of electrodes is arranged in the one or more channels. Confining the set of electrodes to the cylinder head in this manner provides the advantage of positioning the electric field closest to the combustion chamber outlet, fuel and air inlet. The proximity of the set of the electrodes to the combustion chamber provides a minimal decrease in temperature during operation between the combustion chamber. Furthermore, when a gasket carries wires and the set of electrodes for generating the electric field closest to the combustion chamber, the exhaust gases mix with improved control of molecular reformation under minimized temperature difference.

The effectiveness of exhaust gases at any one location is dependent upon the optimized electric field generated by the set of electrodes, hence a feedback loop control of redox through sets of electrodes constitutes “nodes” of control of redox.

Furthermore, a cylinder head gasket may easily be replaced, likewise exhaust manifold gaskets, to provide the advantage of ease of installation or maintenance and promotes the reuse/recycle of cylinder heads and manifold parts.

The combination of the injector electric field and the outlet electric field continue to provide control of combustion reactants and products in an engine in and beyond the combustion chamber. With electric fields continually adjusted, a fuel injection internal combustion engine may comply with the newest air pollution regulation.

The injected fuel describes a fuel injection path. This is the path predominantly taken by the injected fuel. The injector may have multiple nozzles, thereby providing multiple injector paths to the fuel. The injector electric field arranged inside the combustion chamber may be positioned early in the fuel injector path. The injector electric field may cover part of the fuel injector path. The injector electric field may reach beyond the boundaries of the fuel injector path. Or the injector electric field may be a combination of the previously mentioned options.

In a preferred embodiment of the internal combustion engine according to the present invention, the sensor is arranged upstream or downstream of the set of electrodes. When the sensor is arranged upstream of the electrodes, the electric field generated by the set of electrodes may be adapted to the condition of the fluid before the fluid reaches the electric field. When the sensor is arranged downstream of the electrodes a measurement of the effect of the electric field on the fluid may be measured. A second sensor measuring the fluid velocity may advantageously be added upstream or downstream of the set of electrodes to aid in adapting the electric field to the fluid currently flowing through the electric field.

In a preferred embodiment of the internal combustion engine according to the present invention, the sensor is electrically coupled to the set of electrodes for measuring a combustion condition via the electrodes. The sensor may measure a voltage across the electrodes or a current through the electric field for providing a measure of the conductivity of the fluid. The conductivity of the fluid may be a measure for the chemical reactivity of the fluid. The may measure during energizing the fluid or may measure between periods where the fluid is energized. Measuring via the set of electrodes provides the advantage of reducing the electrical wiring in the internal combustion engine. Further, measuring via the set of electrodes provides the advantage of measuring the fluid while positioned in the electric field.

In a preferred embodiment of the internal combustion engine according to the present invention, the set of electrodes is in contact with the fuel, the air and/or the combustion products. This embodiment provides the advantage of that if the fluid is in contact with the set of electrodes, the fluid will also be positioned in the electric field.

In a preferred embodiment of the internal combustion engine according to the present invention, the internal combustion engine comprises an engine block and a cylinder head both forming the combustion chamber, wherein the air inlet channel, the outlet channel and/or the fuel inlet channel are arranged inside the cylinder head.

In a preferred embodiment of the internal combustion engine according to the present invention, the internal combustion engine comprises an engine block and a cylinder head both forming the combustion chamber and the cylinder head comprises two cylinder head modules. Splitting the cylinder head in two modules. The cylinder head, according to this embodiment is defined as a split cylinder head. The split cylinder head provides the advantage of ease of accessibility of the different channels arranged in the cylinder head. Furthermore, the set of electrodes according to the invention may be more easily refurbished with the split cylinder head.

In an embodiment of the present invention, the internal combustion engine further comprises a gasket which is arranged to the internal combustion engine, which gasket comprises electrical wires for electrically connecting the set of electrodes, the gasket further advantageously positions all of the electrodes close to the combustion chamber inlets and outlets to optimally position the electric fields to mix with reactants and combustion products.

The gasket further advantageously provides safety as explained below. Furthermore, the present gasket solves space limitations prohibiting multiple shielded wires for every cylinder from entering the top of an engine already occupied by tightly form fitted engine parts. Furthermore, the present gasket provides the advantage of ease of maintenance and installation due to the improved accessibility, cost and size of the present gasket to be replaced on an engine.

Alternatively, the present gasket comprising the electrodes is positioned between the cylinder head and the engine block.

According to an embodiment of the invention an internal combustion engine comprising: —a combustion chamber comprising an engine block and a cylinder head; and—a gasket which is arranged between the engine block and the cylinder head, which gasket comprises electrical wires for electrically connecting at least the set of electrodes. The gasket will be positioned between the cylinder head and the engine block to form part of the wall of the combustion chamber. The gasket at this position should therefore be able to withstand the high pressures of the combustion chamber.

Alternatively, the present gasket is positioned between the exhaust manifold and the cylinder head. According to an embodiment of the invention an internal combustion engine comprising: —a cylinder head; —an exhaust manifold; and—a gasket which is arranged between the cylinder head and the exhaust manifold, which gasket comprises electrical wires for electrically connecting at least the set of electrodes.

Alternatively, the present gasket is positioned between the exhaust pipe and the exhaust manifold. According to an embodiment of the invention an internal combustion engine comprising: —an exhaust manifold, wherein the exhaust manifold comprises an exhaust opening for coupling to an exhaust pipe; and—a gasket which is arranged to the exhaust opening for positioning the gasket between the exhaust opening and the exhaust pipe, which gasket comprises electrical wires for electrically connecting at least the set of electrodes.

Alternatively, the present gasket may be positioned between the exhaust pipe and the cylinder head. According to an embodiment of the invention an internal combustion engine comprising: —a cylinder head, wherein the cylinder head comprises an exhaust opening for coupling to an exhaust pipe; and—a gasket which is arranged to the exhaust opening for positioning the gasket between the exhaust opening and the exhaust pipe, which gasket comprises electrical wires for electrically connecting at least the set of electrodes.

In an alternative engine embodiment, the cylinder head comprises at least two modules. According to an embodiment of the invention, an internal combustion engine comprising: —a cylinder head, wherein the cylinder head comprises two modules; and—a gasket which is arranged between the two modules, which gasket comprises electrical wires for electrically connecting at least the set of electrodes. The modules of the cylinder head when separated expose a cross section of an air inlet channel, a fuel inlet channel and/or outlet channels closest to the combustion chamber.

The alternative positions of the present gasket, excluding the gasket being part of the combustion chamber, provide the advantage that the gasket does not have to be able to withstand the high pressures of the combustion chamber, thus easing the design of the present gasket compared to an engine “head gasket” located between the cylinder head and engine block. The present gasket can therefore be made to support electrodes and wiring without affecting the volume of the combustion chamber.

Furthermore, the alternative positions of the present gasket may provide the advantage of easing installation and/or replacement due to the improved accessibility. Furthermore, the alternative positions of the gasket may provide the advantage that the engine needs no other change than installing the present gasket in the engine.

The present invention also relates to a motor-vehicle which comprises the internal combustion engine according to the present invention. Suitable examples of motor-vehicles include cars, lorries, motorcycles, moped or any other vehicles carrying a combustion engine.

The invention also relates to a gasket for a fuel injected internal combustion engine. The invention further relates to a motor-vehicle comprising the gasket for the fuel injected combustion engine. The invention further relates to a method for manufacturing the fuel injected combustion engine.

U.S. Pat. No. 6,883,490 B2 proposes an injector comprising three electrodes. The injector is for placement in a fuel injected combustion engine for injecting fuel in a combustion chamber. Tips of the electrodes are arranged to define a polygonal area disposed in proximity to a location where fuel is injected in the combustion chamber. The tips of the electrodes are sourced with electricity to form a volume of electrical ionization in front of or adjacent to the location where fuel is injected. The volume of electrical ionization aids the combustion of the fuel, thereby improving fuel efficiency.

Another disadvantage of U.S. Pat. No. 6,883,490 B2 is that the fuel injected combustion engine has fuel lines and electrical wires running in close proximity to connect to the outer-side of the injector. The fuel lines may develop fuel leaks caused by for example aging or an accident. Electrical wires, of which there would be dozens in quantity, may develop electrical insulation failures also caused by for example aging or an accident. If fuel and electricity come together fuel may ignite outside the combustion engine and may cause the engine to catch fire or worse.

A further object of the invention is therefore to provide a fuel injected combustion engine using an electric field, wherein the engine provides improved safety.

In a further aspect of the present invention, a gasket for an internal combustion engine comprising: —an engine block; —a cylinder head, wherein the engine block and the cylinder head together provide a combustion chamber for combusting a fuel and thereby generating combustion products and wherein the cylinder head comprises at least two cylinder head modules; —a fuel inlet channel for introducing the fuel into the combustion chamber; —a fuel inlet connector for connecting a fuel line to the engine and providing access to the fuel inlet channel; —an air inlet channel for introducing air into the combustion chamber; and—an outlet channel for discharging the combustion products from the combustion chamber; wherein the gasket comprises: —a set of electrodes for generating an electric field in one of the group of the combustion chamber fuel inlet channel, air inlet channel, and the chamber outlet channel, wherein the electric field is preferably arranged inside the cylinder head; —electrical wires for sourcing the electrodes with electrical energy; and—electrical connectors for connecting an electrical generator to the electrical wires, wherein the gasket is arrangeable between the two modules of the cylinder head and when the gasket is arranged to the internal combustion engine, the electrical connectors are on the outside of the internal combustion engine and the electrical connectors are at a predefined distance from the fuel inlet connectors.

The electrical wires running through the gasket will provide electrical connectors on the outside of the engine block away from fuel line. For example, the fuel line may run on one side of the engine to the fuel inlet channel, such as injectors, while the electrical connectors are placed on the other side of the engine, thereby creating a predefined distance between electrical connectors and fuel line. The effect of the predefined distance between the electrical connectors and the fuel line is that the electricity and fuel are separated further from each other. The result of this separation is that in case of a fuel leak and/or an electrical insulation failure the likelihood of the ignition of fuel outside the combustion chamber becomes significantly smaller. If the ignition of fuel outside the combustion chamber is less likely, the engine becomes safer, thereby solving the objective technical problem of providing a safer engine.

The predefined distance may be that the electrical connectors are positioned away from the fuel inlet connector the outside of an internal combustion engine fitted with the inventive gasket. The predefined distance may be that the electrical connectors are positioned above the fuel inlet connector the outside of an internal combustion engine fitted with the inventive gasket. The predefined distance may be that the electrical connectors are positioned are positioned diagonally above each other on the outside of an internal combustion engine fitted with the inventive gasket.

The predefined distance may be that the electrical connectors are positioned on different sides on the outside of the internal combustion engine fitted with the inventive gasket. The predefined distance may be that the electrical connectors are positioned on distinct sides on the outside of the internal combustion engine fitted with the inventive gasket, wherein at least one of the distinct sides is a vertical side of the internal combustion engine.

The present invention also relates to a method for manufacturing the internal combustion engine, wherein the method comprises the steps of: providing an engine block; providing a cylinder head; providing a gasket; and mounting the cylinder head on top of the engine block with the gasket positioned in between, wherein the gasket is according to any of the preceding embodiments of the present invention.

The present invention also relates to a method for combusting a fuel inside the internal combustion engine, the method comprising the steps of: (a) introducing a fuel via the fuel inlet channel into the combustion chamber; (b) introducing air via the air inlet channel into the combustion chamber; (c) combusting the fuel inside the combustion chamber thereby generating combustion products; (d) discharging the combustion products from the combustion chamber via the outlet channel; (e) generating an electric field via the set of electrodes arranged inside the internal combustion engine, which electric field is in contact with the fuel, the air and/or the combustion products; (0 measuring a combustion condition via the sensor arranged inside the internal combustion engine; and (g) adapting the electric field based on the combustion condition.

In a preferred embodiment of the present method or internal combustion engine the outlet channel is arranged inside the cylinder head and the exhaust manifold. This embodiment limits the outlet channel to the cylinder head and the exhaust manifold. This embodiment implicitly excludes the exhaust pipe as being part of the outlet channel. The exhaust pipe is an after treatment system for treatment of an exhaust gas, which is to be distinguished from an internal combustion engine.

In a suitable embodiment of the present method, in step (c) the combustion generates a flame and the electric field is in contact with the flame.

In a suitable embodiment of the method according to the present invention, the combustion condition is measured downstream of the electric field, wherein the electric field is adapted on the basis of the combustion condition.

In addition, the present invention provides a computer program product comprising a computer readable medium having computer readable code embodied therein, the computer readable code being configured such that, on execution by a suitable computer or processor, the computer or processor is caused to perform any of the preceding or succeeding methods. The computer program product provides the advantage of programming the controller used for adapting the electric field based on the measurements.

The present invention also relates to a method for producing a motor-vehicle comprising an internal combustion engine according to the present invention, wherein the method comprises the steps of: (a) providing a motor-vehicle body; (b) providing the internal combustion engine according to the invention; and (c) arranging the internal combustion engine to the motor-vehicle body for allowing the internal combustion engine to drive the motor-vehicle body. This method advantageously provides a motor-vehicle which may provide a cleaner exhaust gas and/or comply to the regulations of different countries, such as the EURO I-VI regulations and/or the 40 Code of Federal Regulations Part 63, Subpart ZZZZ.

### BRIEF DESCRIPTION OF THE FIGURES

The invention will be apparent from and elucidated further with reference to the embodiments described by way of example in the following description and with reference to the accompanying drawings, in which:

FIG. 1 schematically shows a cross-section of an embodiment of an internal combustion engine according to the present invention;

FIG. 2A schematically shows an embodiment of a cylinder head gasket for an internal combustion engine according to the present invention;

FIG. 2B schematically shows a detail of FIG. 2A;

FIG. 3 schematically shows an embodiment of a method for an internal combustion engine according to the present invention;

FIG. 4 schematically shows an embodiment of an electrical wiring for electrodes and sensors according to the present invention;

FIG. 5A schematically shows an embodiment of an electrical circuit for generating a electric field according to the present invention;

FIG. 5B schematically shows an embodiment of a computer control unit and sensors;

FIG. 6A schematically shows an embodiment of a cylinder head with head gasket in exploded perspective view according to the present invention;

FIG. 6B schematically shows an exploded side view of an embodiment of an internal combustion engine according to the present invention; and

FIG. 7 shows schematically an embodiment of a computer program product.

### DETAILED DESCRIPTION

The figures are purely diagrammatic and not drawn to scale. In the Figures, elements which correspond to elements already described may have the same reference numerals provided below.

### REFERENCE DESCRIPTION

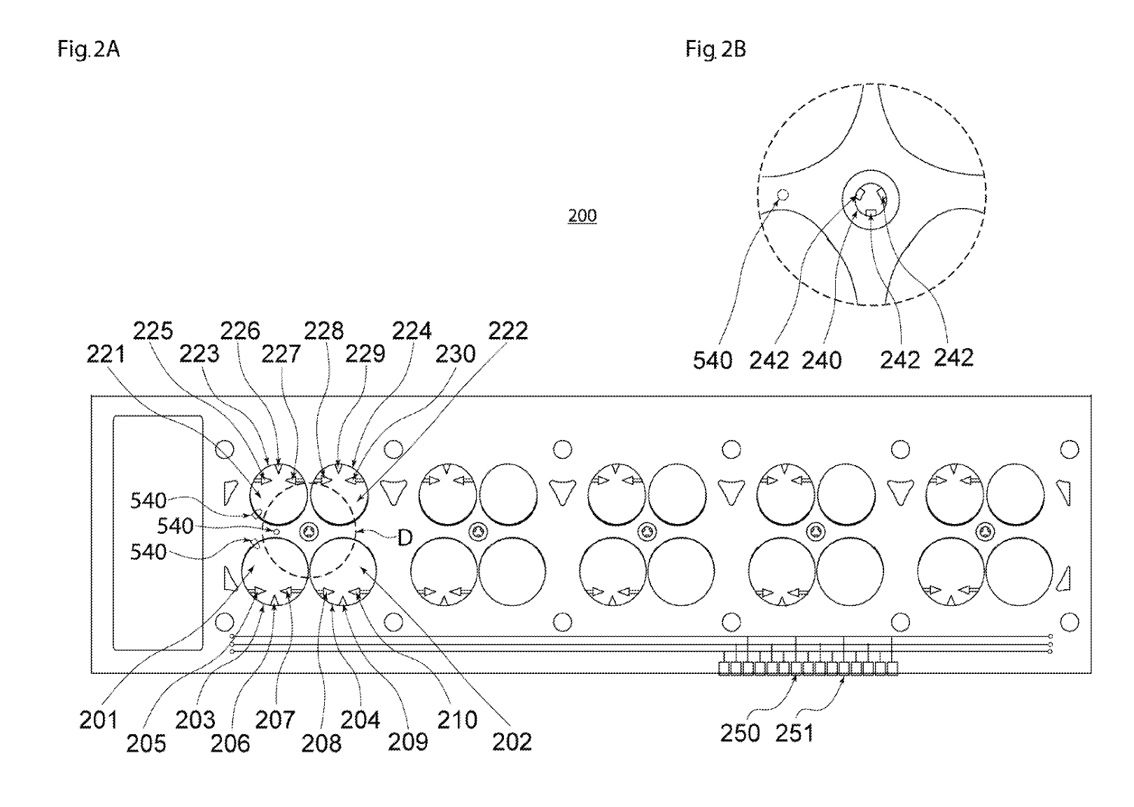

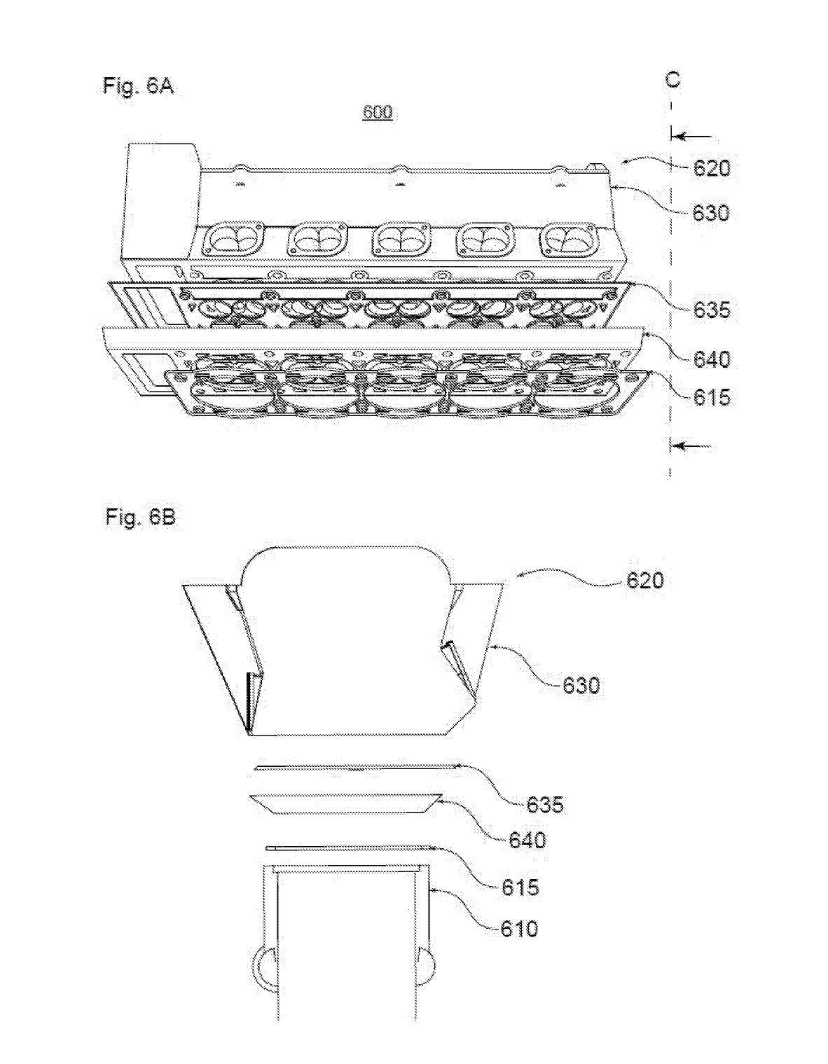

100 engine
104 engine block
105 cylinder head
106 top module, cylinder head
107 bottom module, cylinder head
110 combustion chamber
111 piston
120 air inlet channel
121 air inlet valve, open position
122 fuel direction
123 air direction
124 exhaust gas direction
130 fuel inlet channel
131 fuel inlet valve
140 outlet channel
141 outlet valve, open position
150 electric field positioned in the air inlet channel
151 fuel injection path
152 electric field positioned in the fuel injection path
170 electric field positioned in the exhaust channel
160 cylinder head gasket
201 first air inlet channel
202 second air inlet channel
203 first air inlet channel aperture
204 second air inlet channel aperture
205 first electrode of first air inlet channel aperture
206 second electrode of first air inlet channel aperture
207 third electrode of first air inlet channel aperture
208 fourth electrode of second air inlet channel aperture
209 fifth electrode of second air inlet channel aperture
210 sixth electrode of second air inlet channel aperture
221 first outlet channel
222 second outlet channel
223 first outlet channel aperture
224 second outlet channel aperture
225 first electrode of first outlet channel aperture
226 second electrode of first outlet channel aperture
227 third electrode of first outlet channel aperture
228 fourth electrode of second outlet channel aperture
229 fifth electrode of second outlet channel aperture
230 sixth electrode of second outlet channel aperture
240 injector aperture
242 set of injector electrodes
250 electrical connectors location
251 electrical connectors
300 method for internal combustion engine
310 introducing fuel
315 introducing air
320 combusting fuel
325 discharging
330 generating electric field
335 measuring combustion condition
340 adapting electric field
400 electrical wiring
410 first electrical connector
411 second electrical connector
412 third electrical connector
413 common wire
420 first electrical circuit
421 second electrical circuit
422 third electrical circuit
430 mesh
431 second electrical generator
500 electrical circuit
501 transformer
502 signal wire
510 positive voltage source connector
511 negative voltage source connector/ground
520 first capacitor
521 second capacitor
522 third capacitor
523 diode
524 resistor
531 transistor
532 signal input
533 signal to second electrical generator 431
540 sensor
550 control unit
600 internal combustion engine
610 engine block
615 head gasket
620 cylinder head
630 cylinder top
635 circuit gasket
640 skull section
800 computer readable storage medium
810 writable part
820 computer program
A direction reciprocating motion piston
B signal
B1 signal
C viewing line in FIG. 6A
D detail enlarged in FIG. 2B

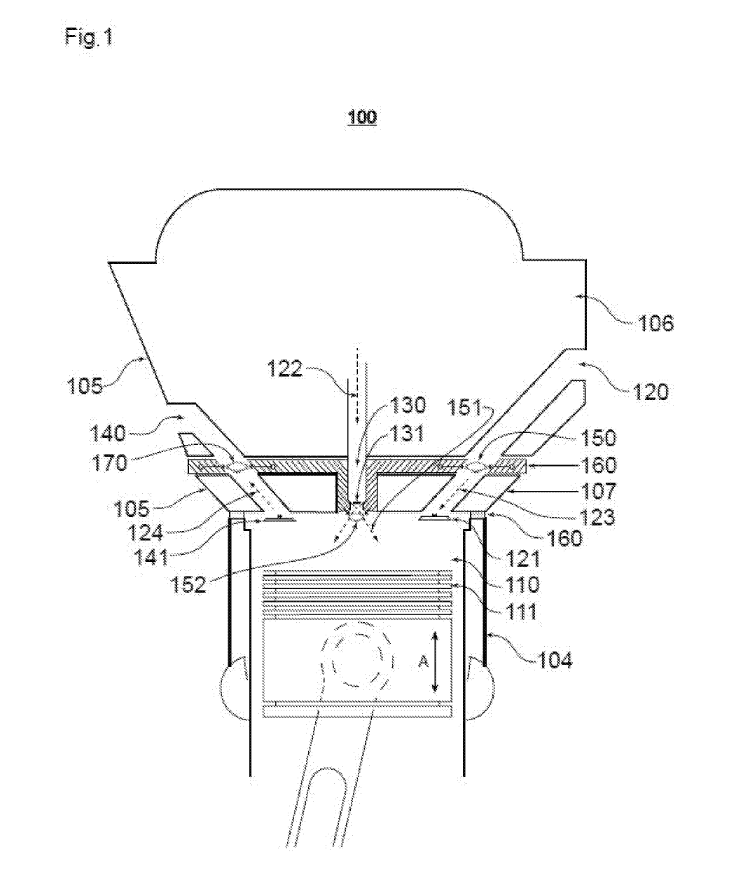

FIG. 1 schematically shows a cross-section of an embodiment of an internal combustion engine 100 according to the present invention. The combustion engine 100 comprises a cylinder head 101 and an engine block 104. The combustion engine 100 further comprises a combustion chamber 110 defined by the cylinder head 105 and the engine block 104. The combustion engine 100 further comprises a piston 111 arranged inside the engine block 104. The piston 111 makes a reciprocating motion in a direction A during operation.

The combustion engine 100 further comprises an air inlet channel 120, a fuel inlet channel 130 and an outlet channel 140. The air inlet channel 120 provides air to the combustion chamber 110. The air inlet channel 120 guides the air predominantly in the air direction 123. An air inlet valve 121 may be positioned where the air inlet channel 120 connects to the combustion chamber 110. The air inlet valve 121 may be closed or opened (as depicted) to allow air into the combustion chamber only at predefined moments in time. For example, the air inlet valve 121 may be closed during combustion inside the combustion chamber 110 and discharge of the combustion chamber 110.

The fuel inlet channel 130 may comprise a fuel inlet valve 131 or fuel injector, which injects fuel into the combustion chamber 110 via a fuel injection path 151. Alternatively, the fuel inlet channel 130 may comprise a carburetor for allowing fuel into the combustion chamber 110. The fuel inlet valve 131 injects fuel only at predefined moments in time. The fuel inlet channel 130 guides the fuel predominantly in the fuel direction 122.

The outlet channel 140 receives an exhaust gas that is expelled from the combustion chamber 110. The outlet channel 140 guides the exhaust gas predominantly in the exhaust gas direction 124. An outlet valve 141 may be positioned where the outlet channel 140 connects to the combustion chamber 110. The outlet valve 140 may be closed or opened to allow exhaust gas out of the combustion chamber 110 only at predefined moments in time. For example, the outlet valve 141 may be in the open position (as depicted) during discharge of the combustion chamber 110.

The cylinder head 105 comprises a top module 106 and a bottom module 107. The top module 106 is arranged on top of the bottom module 107. The engine 100 further comprises a cylinder head gasket 160 disposed between the top module 106 and bottom module 107.

The cylinder head gasket 160 comprises electrodes 205, 206, 207, 208, 209, 210, 225, 226, 227, 228, 229, 230, 242 for generating an electric field 150, 152, 170. The electric field 170 may be positioned in the outlet channel 140 for allowing contact with combustion products when the combustion chamber 110 is discharged. During discharge combustion products mix with the electric field 150, 152, 170 providing ionized and/or charged exhaust gas. The ionized and/or charged exhaust gas will become highly reactive and will continue the redox reaction. Also when the ionized and/or charged fuel, air and incomplete reaction product come into contact with the flame, the flame will continue to exist. Hence the electric field sustains the redox reaction and/or the flame in time and/or space. The effects of prolonging and/or intensifying the redox reaction and/or the flame will be that the ionized and/or charged fuel, air and incomplete reaction product will further react to complete combustion products. The result of the further reaction will be that a cleaner exhaust gas will be discharged from the internal combustion engine 100.

The exhaust gas may be further treated in an exhaust pipe (not depicted) before being released into the outside air. The exhaust pipe is not considered part of the internal combustion engine 100.

Alternatively, the electric field 150 may be positioned in or in front of the fuel inlet channel 130 for allowing contact with fuel when or preceding the step that the combustion chamber 110 is loaded with fuel. Alternatively, the electric field 170 may be positioned in or in front of the air inlet channel 120 for allowing contact with air when or preceding the step that the combustion chamber 110 is loaded with air.

FIG. 2A schematically shows an embodiment of a cylinder head gasket 160 for an internal combustion engine 100 according to the present invention. The cylinder head gasket 160 depicted is for use in an internal combustion engine 100 having five cylinders. Although only the features of the cylinder head gasket 160 for the first cylinder are presented, it is to be understood that the features for other cylinders will be similar to the features of the first cylinder.

The internal combustion engine 100, according to this embodiment, comprises an air inlet channel 120 split in two channels: a first air inlet channel 201 and a second air inlet channel 202. The cylinder head gasket 160 provides a first air inlet channel aperture 203 for the first air inlet channel 201 and a second air inlet aperture 204 for the second air inlet channel 202. The cylinder head gasket 160 further comprises a first set of inlet electrodes arranged on the inside of the first air inlet aperture 203. The first set of inlet electrodes comprises a first 205, a second 206 and a third 207 air inlet electrode. The cylinder head gasket 160 further comprises a second set of air inlet electrodes arranged on the inside of the second air inlet aperture 204. The second set of air inlet electrodes comprises a fourth 208, a fifth 209 and a sixth 210 air inlet electrode.

The internal combustion engine 100 comprises an outlet channel 140 split in two channels: a first outlet channel 221 and a second outlet channel 222. The cylinder head gasket 160 provides a first outlet channel aperture 223 for the first outlet channel 221 and a second outlet aperture 224 for the second outlet channel 222. The cylinder head gasket 160 further comprises a first set of inlet electrodes arranged on the inside of the first outlet channel aperture 223. The first set of outlet electrodes comprises a first 205, a second 206 and a third 207 outlet electrode. The cylinder head gasket 160 further comprises a second set of outlet electrodes arranged on the inside of the second outlet channel aperture 224. The second set of outlet electrodes comprises a fourth 208, a fifth 209 and a sixth 210 inlet electrode.

FIG. 2B schematically shows a detail indicated by a dotted circle D in FIG. 2A. The cylinder head gasket 160 provides an injector aperture 240 for arranging the injector to the aperture. The cylinder head gasket 160 further comprises a set of injector electrodes 242 arranged on the inside of the first injector aperture 240. The set of injector electrodes 242 comprises three electrodes.

The different sets of electrodes 205, 206, 207, 208, 209, 210, 225, 226, 227, 228, 229, 230, 242 may be used to generate different electric fields and currents. The electric field affects a fluid, such as a gas and/or a liquid, passing through the electric field. For the injector electrodes this fluid will be fuel. For the air inlet electrodes 205, 206, 207, 208, 209, 210 this fluid will be air. For the outlet electrodes 225, 226, 227, 228, 229, 230 this fluid will be at least combustion products.

The cylinder head gasket 160 comprises a set of injector electrodes 242 and/or air inlet electrodes 205, 206, 207, 208, 209, 210 to initiate, prolong and/or intensify a combustion reaction such as a redox reaction. The cylinder head gasket 160 comprises a set of outlet electrodes 225, 226, 227, 228, 229, 230 to sustain the redox reaction in the combustion chamber 110 and/or the outlet channel 140. The cylinder head gasket 160 may comprise a set of outlet electrodes 225, 226, 227, 228, 229, 230, and at least one of a set of injector electrodes 242, and a set of air inlet electrodes 205, 206, 207, 208, 209, 210 combined with a sensor 540 for measuring a combustion conditions, and a controller 540 for controlling the sets of electrodes 205, 206, 207, 208, 209, 210, 225, 226, 227, 228, 229, 230, 242 based on the measurements from the sensor 540 to provide control of redox reactivity.

The cylinder head gasket 160 may further comprise an electrical connector location 250. The electrical connector location 250 comprises several electrical connections 251. Each electrical connection 251 is connected to one or more electrodes 205, 206, 207, 208, 209, 210, 225, 226, 227, 228, 229, 230, 242 by way of electrical wires (not depicted). The electrical wires may be embedded in the cylinder head gasket 160. Alternatively, the electrical wires may be attached to a surface of the cylinder head gasket 160. The electrical connector location 250 allows the electrical connections 251 to external electrical sources to be grouped, such as for example an electrical generator (not depicted).

The electrical connector location 250 increases the distance between the location where the fuel lines bring fuel to the engine 100 and the location where electrical energy is brought to the engine 100. This increase of distance provides an increase in safety as described above.

A cylinder head gasket 160 may be arranged to a part of the engine 100, wherein the cylinder head gasket 160 is not part of the combustion chamber 110. This arrangement of the cylinder head gasket 160 provides the advantage of increased tolerances. The cylinder head gasket 160 for the combustion chamber 110 is confined to tight tolerances, high temperatures and/or high pressures. The tight tolerances limit the cross section and amount of electrical wires added to the cylinder head gasket 160. The high pressures require a material which is able to withstand these, such as a rigid or hard material. The high temperatures also require a material which is able to withstand these, such as a temperature hard material.

Additionally, a high temperature has a negative influence on the conductance of the electrical wires contradicting the tight tolerances. Hence, arranging the cylinder head gasket 160 at another location than the combustion chamber 110 provides a simplified cylinder head gasket design. As an example, a cylinder head gasket 160 may advantageously be arranged between modules of a split cylinder head of a split cylinder head internal combustion engine 110, wherein the cylinder head gasket 160 is not part of the combustion chamber 110, but an internal part of the cylinder head 105.

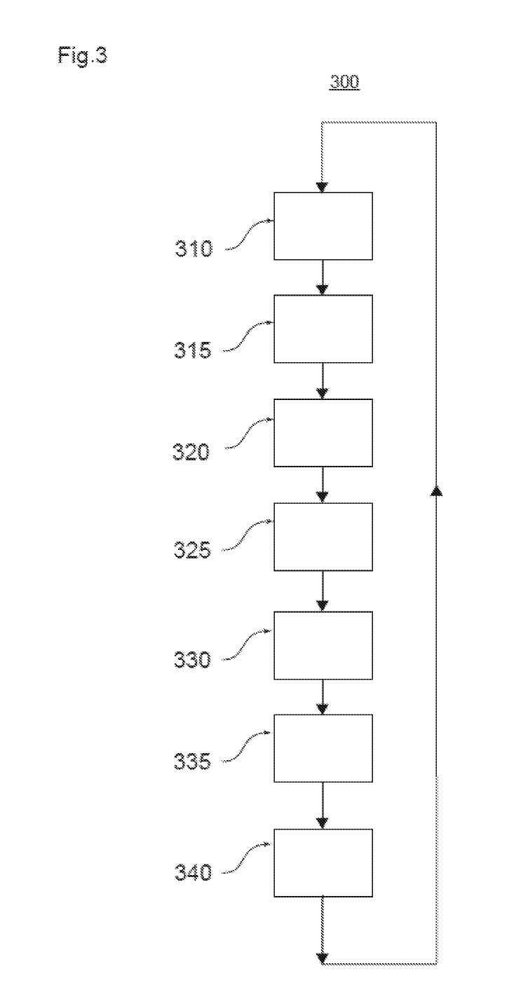

FIG. 3 schematically shows an embodiment of a method 300 for an internal combustion engine 100 according to the present invention. The method 300 starts with the step of introducing 310 a fuel via the fuel inlet channel 130 into the combustion chamber 110. After the introducing step, the method continues with the step of introducing 315 air via the air inlet channel 120 into the combustion chamber 110. Alternatively, the introducing steps are swapped in sequence or are executed simultaneously. After the introducing steps 310, 315, the method 300 continues with the step of combusting 320 the fuel inside the combustion chamber 110 thereby generating combustion products. After the combusting step 320, the method 300 continues with the step of discharging 325 the combustion products from the combustion chamber 110 via the outlet channel 140. After the discharging step 325, the method 300 continues with the step of generating 330 an electric field 150, 152, 170 via the set of electrodes 205, 206, 207, 208, 209, 210, 225, 226, 227, 228, 229, 230, 242 arranged inside the internal combustion engine 100, which electric field 150, 152, 170 is in contact with the fuel, the air and/or the combustion products.

Alternatively, the generating step 330 is executed during one or more of the introducing steps 310, 315, combustion step 320 or discharging step 325. After the generating step 330, the method 300 continues with the step of measuring 335 a combustion condition via the sensor 540 arranged inside the internal combustion engine 100. Alternatively, the step of measuring 335 is done prior to or during the generating step 330. After the measuring step 335, the method 300 continues with the step of adapting 340 the electric field 150, 152, 170 based on the combustion condition. Alternatively, the step of adapting 340 is done prior to or during the measurement step 335, wherein the adapting is based on a previous measurement step 335. The skilled person will understand that this sequence of process steps can be continuously repeated.

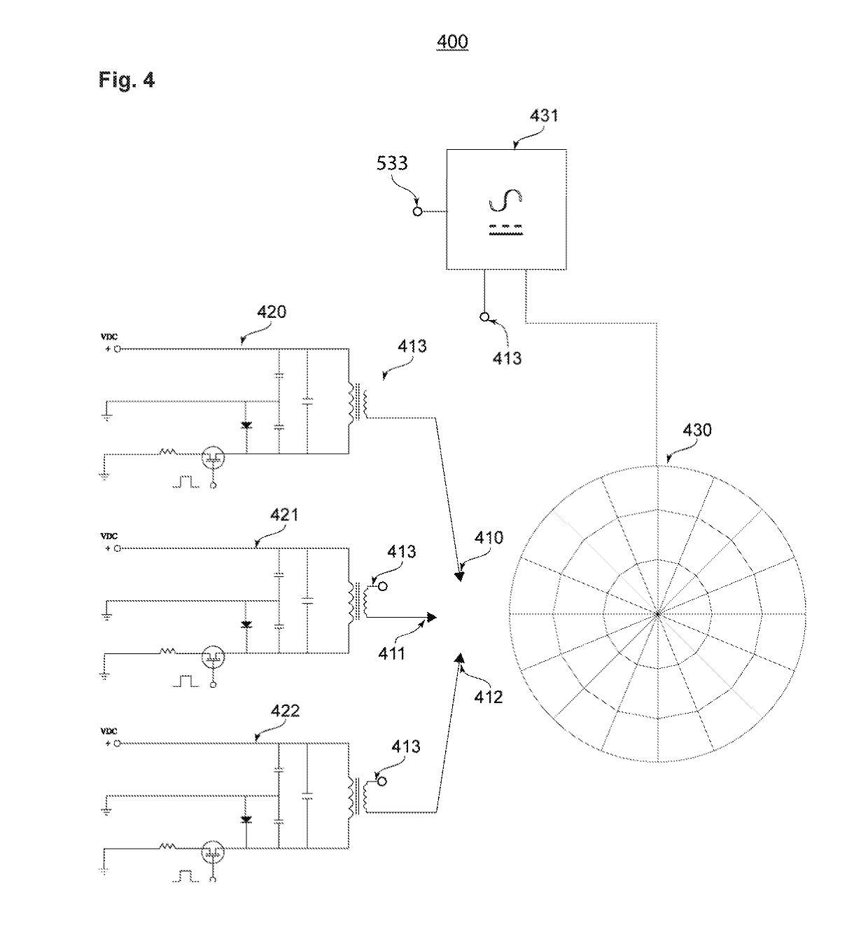

FIG. 4 schematically shows an embodiment of an electrical wiring 400 for electrodes 205, 206, 207, 208, 209, 210, 225, 226, 227, 228, 229, 230, 242 according to the present invention. The electrical wiring comprises a first 410, a second 411 and a third 412 electrode connector for connecting to a first electrode, a second electrode and a third electrode respectively (any combination of the electrodes 205, 206, 207, 208, 209, 210, 225, 226, 227, 228, 229, 230, 242). The first, second and third electrode may form a set of electrodes together.

The electrical wiring 400 further comprises a first 420, a second 421 and a third 422 electrical circuit for generating electrical energy for sourcing the respective electrodes 205, 206, 207, 208, 209, 210, 225, 226, 227, 228, 229, 230, 242 for generating an electric field 150, 152, 170. The electrical circuits may be connected to a first electrical generator for sourcing the electrical circuits with electrical energy. The electrical circuits 420, 421, 422 are connected to a common wire 413 to allow the electrical circuits to generate an electrical voltage difference between the respective electrodes 205, 206, 207, 208, 209, 210, 225, 226, 227, 228, 229, 230, 242. This connection of the electrical circuits 420, 421, 422 may be seen as a star configuration. Alternatively, the electrical circuits 420, 421, 422 may be connected in a delta configuration. In the delta configuration the common wire 413 may be omitted.

Optionally, the electrical wiring 400 comprises a mesh 430 positioned downstream of the set of electrodes (any combination of the electrodes 205, 206, 207, 208, 209, 210, 225, 226, 227, 228, 229, 230, 242). The electrical wiring 400 further comprises a second electrical generator 431 connecting the mesh 430 to the common wire 413. The second electrical generator may be a function generator. The second electrical generator may be a current source. The current source may generate a current flow having the shape of a DC current, square wave current, sinus current, triangle current, saw tooth current or pulse current in time. Alternatively, the second electrical generator may be a voltage source generating a voltage having a shape similar to the previously mentioned current shapes. The voltage difference between the mesh and the common wire 413 provides a directional force to the current between the electrodes 205, 206, 207, 208, 209, 210, 225, 226, 227, 228, 229, 230, 242. The directional force increases the volume of the electric field 150, 152, 170 having the effect of improving the contact between the electric field 150, 152, 170 and a fluid, such as a gas and/or a liquid, which passes through the electric field 150, 152, 170.

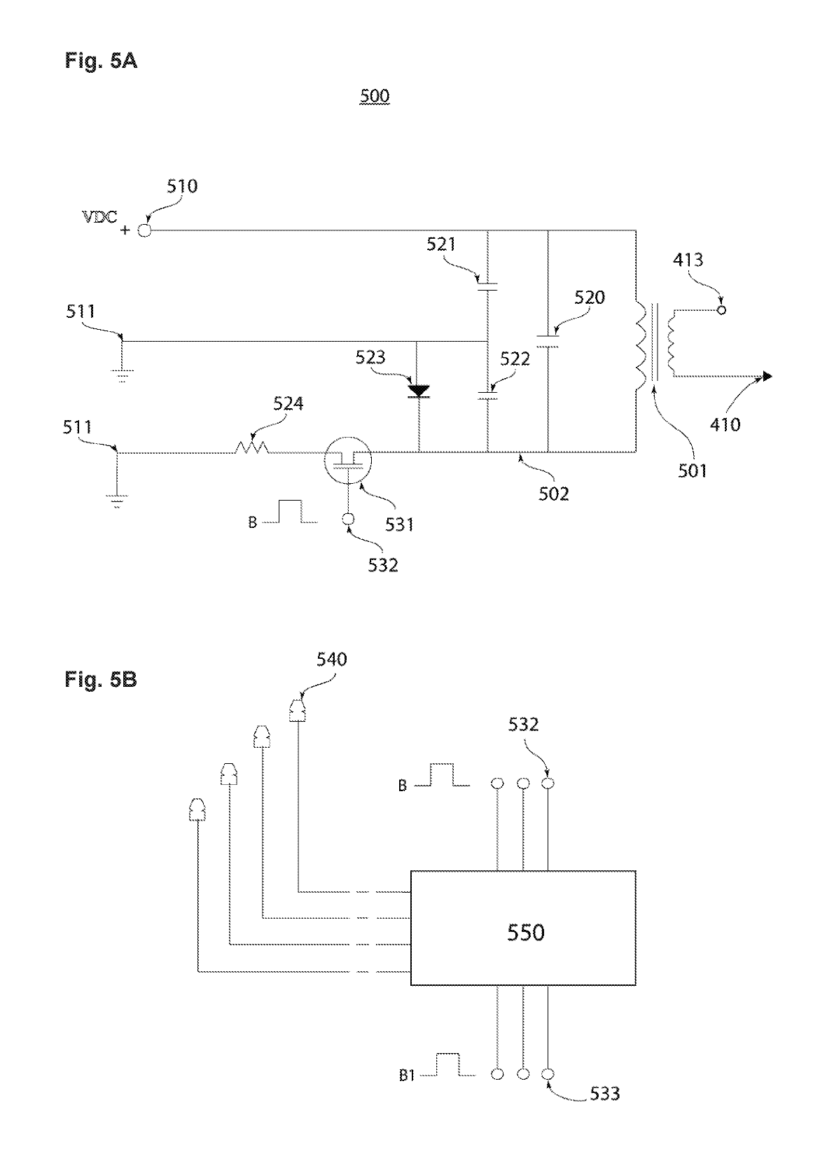

FIG. 5A schematically shows an embodiment of an electrical circuit 500 for generating an electric field 150, 152, 170 according to the present invention. The electrical circuit comprises a transformer 501.

According to an embodiment of FIG. 5B, the control unit 550 controls the electric field 150, 152, 170 produced by circuit 500, by switching the electric field 150, 152, 170 on or off, according to sensor 540 and computer program 820. Other embodiments of the control unit 550 for controlling frequency and/or electric field strength of circuit 500 are envisioned for adapting the electric field for optimizing the redox reactivity. The control unit 550 also signals 533 the second electrical generator 431, to produce an electrical current at the output of the generator, according to the signal received from sensor 540 and computer program 820.

The transformer 501 comprises a high voltage winding having two high voltage outputs, which are connected to respectively the common wire 413 and the first 420, second 421, or third electrode 422 of an electrical wiring 400, for example the electrical wiring 400 of FIG. 4.

The transformer 501 comprises a low voltage winding having two low voltage outputs. One low voltage output is connected to a positive voltage source connector 510 for connecting to a positive side of a voltage source. The other low voltage output is connected to a signal wire 502.

The electrical circuit 500 further comprises a first capacitor 520 connected between the positive voltage source connector 510 and the signal wire 502. The electrical circuit 500 further comprises a second capacitor 521 connected between the positive voltage source connector 510 and a ground 511. The ground 511 may be a negative voltage source connector for connecting to a negative side of the voltage source. The electrical circuit 500 further comprises a third capacitor 522 and a diode 523 both connected in parallel between the ground 511 and the signal wire 502. The orientation of the diode 523 is such that the diode 523 is conductive when the voltage of the ground 511 is higher in reference to the signal wire 502. The electrical circuit 500 further comprises a transistor 531 and a resistor 524 connected in series from the signal wire 502 to the ground 511, wherein the transistor 531 collector and emitter or source and drain are connected in series. The electrical circuit 500 further comprises a signal input 532 connected to a base input or a gate input of the transistor 531. The signal input 532 may be connected to a square wave generator providing a signal B for controlling the voltage of the electrode connector for ultimately controlling the electric field 150, 152, 170. Either the signal input 532 directly or via a square wave generator is connected to the controller according to the invention for controlling the electric field 150, 152, 170 and thereby controlling redox reactivity.

The first capacitor 520 may have a capacitance of 47 nF, 0.1 μf or 2.2 nF. The second capacitor 521 may have a capacitance of 4.7 nF, 2.2 nF, 0.1 μF or 1.0 μf. The third capacitor 522 may have a capacitance of 4.7 nF or 2.2 nF. The diode 523 may be a fast acting, high amperage diode. The resistor 524 may be a 0.2 ohm resistor. The transistor 531 may be a Metal-Oxide-Semiconductor Field-Effect Transistor (MOSFET).

If the transistor 531 is in a non-conducting mode of operation, the voltage at the signal wire 502 will be equal to a positive voltage of the positive voltage source connector 510 and no current will flow through the low voltage windings of the transformer 501. As a consequence, no voltage difference will be present over the outputs of the high voltage side of the transformer 501.

If the transistor 531 switches from the non-conducting to a conducting mode of operation in combination with the resistor 524 having a low resistance, this will cause the signal wire 502 voltage to become close to ground 511. The voltage over the low voltage windings of the transformer 501 will cause a current to start flowing through the low voltage windings of the transformer 501. The transformer 501 will develop a counter acting voltage to counteract this current flow. This counter acting voltage will also be present between the high voltage outputs of the transformer 501 multiplied by the ratio of windings on the high voltage side and the windings on the low voltage side. Due to this ratio the counter acting voltage on the high voltage side will be much higher compared to the low voltage side. This counter acting voltage will fade away, for instance exponentially, due to resistive losses in the transformer 501. The switching of the transistor 531 will therefore cause a voltage spike of high voltage on the high voltage outputs. The electrical system will provide in a new balance wherein a constant current flows through the transformer 501 low voltage windings.

If the transistor 531 is subsequently switched from the conducting to the non-conducting mode of operation the flow of current through the transistor 531 will be switched off. The transformer 501 has the natural tendency to continue the current flow through the low voltage winding. For the current to continue to flow, the transformer 501 will generate a voltage over the low voltage windings to sustain this current flow. This voltage will cause the capacitors 520, 521, 522 to be drained of charge. This voltage is enlarged in the same way as previously described to a higher voltage on the high voltage outputs of the transformer 501.

The diode 523 may prevent a reverse voltage over the transistor 531. The system may start ringing if the effects of the high voltage spikes on the high voltage windings of the transformer 501 are taken into account. These high voltage spikes, taking into account the charged volume between the electrodes 205, 206, 207, 208, 209, 210, 225, 226, 227, 228, 229, 230, 242, may cause the system to behave as a resonant tank circuit that starts ringing. An effect of this may be breakdown and/or discharge between electrodes causing a spark. Depending on frequency, voltage height and atmospheric circumstances between the electrodes 205, 206, 207, 208, 209, 210, 225, 226, 227, 228, 229, 230, 242, the electric field 150, 152, 170 may behave differently. The purpose of the electric field 150, 152, 170 according to the invention is to control redox reactivity. In accordance with an example embodiment of the present invention, the creation of a spark caused by the breakdown and/or discharge between electrodes 205, 206, 207, 208, 209, 210, 225, 226, 227, 228, 229, 230, 242 can be utilized in spark ignited engines. Accordingly, the redox reactivity provided by the present invention can be utilized to replace the need of spark plugs in spark ignition internal combustion engines 100.

According to the embodiment of FIG. 5, the controller circuit 500 controls the electric field 150, 152, 170 by switching the electric field 150, 152, 170 on or off. Other embodiments of the controller circuit 500, controlling frequency and/or electric field strength are envisioned for adapting the electric field for optimizing the redox reactivity.

Control may include exposure time to the electric fields 150, 152, 170 based on the number of discharges per second of the set of electrodes 205, 206, 207, 208, 209, 210, 225, 226, 227, 228, 229, 230, 242. Too many discharges may lead to too much ionization resulting in less clean exhaust emissions. Too much ionization of fuel may result in a loss of reactivity leading to a loss of power leading to less clean exhaust emissions; and, too much ionization of oxygen may result in too much oxygen species in the exhaust for less clean exhaust. Thus, the number of discharges is increased or decreased to increase or decrease the amount of ionized fuel and ionized oxygen respectively. Exposure time may be different for different engine types such as diesel, petrol, fuel injected, and carburetor type engines.

Control may include the amount of voltages needed to ionize fuel and oxygen, together or separately. The ionization of oxygen may have a different voltage than ionizing hydrocarbon fuel so that an increase or decrease in voltage may result in more oxygen than fuel being ionized and vice versa. Too much voltage may result in too much ionization of one or the other reactant resulting in less clean exhaust; Too much voltage may result in wasted electricity with no appreciable benefit to either reactant, or out of balanced stoichiometry (air pollution) or out of balanced oxidation and reduction reactivity (air pollution). Voltage may also need to be controlled differently for different engine and fuel types.

Control may include the amount of current that increases reduction reactivity. Reduction reactivity primarily occurs during the combustion reaction, therefore current may be delivered during combustion to increase reduction reactivity. Not enough current will lead to too little reduction reactivity compared to ionized fuel and oxygen. This may result in less oxygen consumed in the reaction and/or too much oxygen species expelled to the exhaust (air pollution). Current delivered beyond what improves reduction reactivity does not produce more reduction reactivity rather produces wasted current.

Control may include an ongoing balance of current and voltage that increases reduction reactivity in relationship to the ionization of the fuel and oxygen. The exposure to voltages that ionize in relationship to currents that reduce can be increased or decreased to maintain a balance resulting in the ongoing control of redox reactivity.

Control may include the balance in amounts fuel and oxygen, such as air supplied to the engine. In a typical internal combustion engine oxygen and fuel are delivered in amounts that are balanced according to optimal stoichiometry of the engine 100. This means an optimal amount of fuel mixing with the optimal amount of oxygen based on the combustion chamber 110 size and other mechanical determinants to produce the most amount of power and the cleanest exhaust possible, most oxygen any hydrocarbon consumed in the process. Voltage and current like oxygen and fuel are related in amounts delivered in a balanced way for optimal stoichiometry. Electronic control of redox may increase the consumption of oxygen in the hydrocarbon combustion reaction, reducing CO2, NOx, CO and other oxygen species in the exhaust.

FIG. 6A schematically shows an embodiment of a cylinder head 620 with head gasket 615 in exploded perspective view according to the present invention. The cylinder head 620 comprises a cylinder top 630, a skull section 640 and a circuit gasket 635 arranged between the cylinder top 630 and the skull section 640. The circuit gasket 635 may comprise electric wires and electrodes, such as described in FIG. 2. The skull section 640 of a cylinder head 620 contains the fuel, air, and exhaust ports, and seats the valves. The presented cylinder head 620 may be defined as a split cylinder head.

FIG. 6B schematically shows an exploded side view of an embodiment of an internal combustion engine 600 according to the present invention. The side view is from dotted line C shown in FIG. 6A in the direction of the arrows. The internal combustion engine 600 comprises an engine block 610, a cylinder head 620 and a head gasket 615 arranged between the engine block 610 and the cylinder head 620.

In operation, the best method for electronically increasing redox reactivity in modern internal combustion engines (e.g., engine 100) begins in front of the fuel injector (e.g., fuel inlet valve 131) and directly at the exhaust outlet of the combustion chamber (e.g., combustion chamber 110). Increasing redox reactivity can continue downstream, using “redox gaskets” (e.g., cylinder head gasket 160) between the cylinder head (e.g., cylinder head 105) and the exhaust manifold, and at the exhaust manifold outlet before any exhaust after-treatment. It is ideal to increase redox reactivity in as many stages as needed or possible within an engine. Given the way internal combustion engines are made, the best access to redox locations is through a split-head design. As would be appreciated by one skilled in the art, placement of the electrodes (e.g., electrodes 205, 206, 207, 208, 209, 210, 225, 226, 227, 228, 229, 230, 242) is the same for all engine designs (e.g., in front of the fuel injector, at the exhaust outlet of the combustion chamber, and in as many stages as possible or needed downstream). For example, electronically increasing redox reactivity can also be applied to fuel-oil burners and other types of combustible fuel engines. With other combustible engine types the locations of the redox reactions and electrodes are also at the fuel injector in the combustion chamber and right at the exhaust outlet.

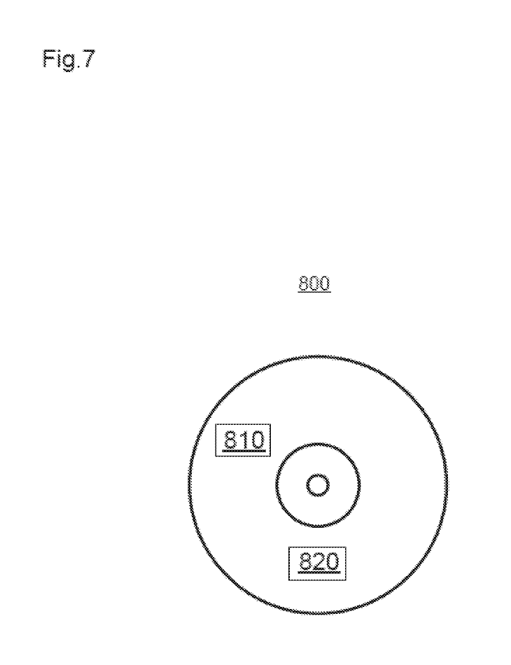

FIG. 7 shows schematically an embodiment of a computer program product, a computer readable medium or a non-transitory computer readable storage medium 800 having a writable part 810 including a computer program 820, the computer program including instructions for causing a processor system to perform steps according to a method of an embodiment of the invention.

In the foregoing specification, the invention has been described with reference to specific examples of embodiments of the present invention. It will, however, be evident that various modifications and changes may be made therein without departing from the scope of the invention as set forth in the appended claims. For example, the connections may be any type of connection suitable to transfer signals from or to the respective modules, units or devices, for example via intermediate devices. Accordingly, unless implied or stated otherwise the connections may for example be direct connections or indirect connections.

Devices functionally forming separate devices may be integrated in a single physical device. Also, the units and circuits may be suitably combined in one or more semiconductor devices.

However, other modifications, variations and alternatives are also possible. The specifications and drawings are, accordingly to be regarded in an illustrative rather than in a restrictive sense.

In the claims, any reference signs placed between parentheses shall not be construed as limiting the claim. The word ‘comprising’ or ‘including’ does not exclude the presence of other elements or steps than those listed in a claim. Furthermore, the terms “a” or “an,” as used herein, are defined as one or as more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

What is claimed is:

1. Internal combustion engine comprising:
a combustion chamber for combusting a fuel and thereby generating combustion products;
a fuel inlet channel for introducing the fuel into the combustion chamber;
an air inlet channel for introducing air into the combustion chamber;
an outlet channel for discharging the combustion products from the combustion chamber;
a set of electrodes arranged inside the internal combustion engine for generating an electric field in contact with the fuel, the air and/or the combustion products when a voltage is applied across the set of electrodes;
a sensor arranged inside the internal combustion engine for measuring a combustion condition; and
a controller for adapting the electric field based on the combustion condition.

2. Internal combustion engine according to claim 1, wherein the set of electrodes is arranged in the air inlet channel, the outlet channel, the fuel inlet channel or the combustion chamber.

3. Internal combustion engine according to claim 1, wherein the combustion generates a flame and the electric field is in contact with the flame.

4. Internal combustion engine according to claim 1, wherein the sensor is arranged to the air inlet channel, the outlet channel, the fuel inlet channel or the combustion chamber.

5. Internal combustion engine according to claim 1, wherein the sensor is arranged upstream or downstream of the set of electrodes.

6. Internal combustion engine according to claim 1, wherein the sensor is electrically coupled to the set of electrodes for measuring a combustion condition via the electrodes.

7. Internal combustion engine according to claim 1, wherein the set of electrodes is in contact with the fuel, the air and/or the combustion products.

8. Internal combustion engine according to claim 1, which the internal combustion engine comprises an engine block and a cylinder head both forming the combustion chamber, wherein the air inlet channel, the outlet channel and/or the fuel inlet channel are arranged inside the cylinder head.

9. Internal combustion engine according to claim 8, wherein the cylinder head comprises two cylinder head modules.

10. Internal combustion engine according to claim 8, comprising a gasket, wherein the gasket is arranged between the engine block and the cylinder head; and
the gasket comprises electrical wires for electrically connecting the set of electrodes.

11. Internal combustion engine according to claim 9, comprising a gasket, wherein the gasket is arranged between the two cylinder head modules; and
the gasket comprises electrical wires for electrically connecting the set of electrodes.

12. Internal combustion engine according to claim 1, comprising:
a second set of electrodes arranged inside the internal combustion engine for generating a second electric field in contact with the fuel, the air and/or the combustion products; and/or
a second sensor arranged inside the internal combustion engine for measuring a second combustion condition.

13. Motor-vehicle comprising an internal combustion engine according to claim 1.

14. Method for combusting a fuel inside an internal combustion engine according to claim 1, the method comprising the steps of:
(a) introducing a fuel via the fuel inlet channel into the combustion chamber;
(b) introducing air via the air inlet channel into the combustion chamber;
(c) combusting the fuel inside the combustion chamber thereby generating combustion products;
(d) discharging the combustion products from the combustion chamber via the outlet channel;
(e) generating an electric field via the set of electrodes arranged inside the internal combustion engine, which electric field is in contact with the fuel, the air and/or the combustion products;
(f) measuring a combustion condition via the sensor arranged inside the internal combustion engine; and
(g) adapting the electric field based on the combustion condition.

15. Method according to claim 14, wherein in step (c) the combustion generates a flame and the electric field is in contact with the flame.

16. Computer program product for combusting a fuel inside an internal combustion engine, the computer program product comprising a computer readable medium having computer readable code embodied therein, the computer readable code being readable/executable by a computing device to cause the computing device to:
(a) introduce a fuel via the fuel inlet channel into the combustion chamber;
(b) introduce air via the air inlet channel into the combustion chamber;
(c) combust the fuel inside the combustion chamber thereby generating combustion products;
(d) discharge the combustion products from the combustion chamber via the outlet channel;
(e) generate an electric field via the set of electrodes arranged inside the internal combustion engine, which electric field is in contact with the fuel, the air and/or the combustion products;
(f) measure a combustion condition via the sensor arranged inside the internal combustion engine; and
(g) adapt the electric field based on the combustion condition.
